(19) United States
(12) Patent Application Publication
(10) Pub. No.: US 2023/0070389 A1
(43) Pub. Date: Mar. 9, 2023

(54) SYSTEM AND METHOD FOR CREATING NFT FROM PHYSICAL ASSET AND VALIDATING AUTHENTICITY OF NFT ASSOCIATED ASSET

(71) Applicant: VLINDER INC., Monroe, NJ (US)

(72) Inventors: SRINIVASAN MADHUSUDHAN, Bengaluru (IN); Gururaja Narayana, Bengaluru (IN); KALIRAJ SUBRA MANIAN, Bengaluru (IN)

(21) Appl. No.: 17/902,803

(22) Filed: Sep. 3, 2022

(30) Foreign Application Priority Data
Sep. 3, 2021 (IN) 202141039935

(51) Int. Cl. G06Q 30/00; G06Q 20/38; G06Q 20/32; G06Q 10/08

(52) U.S. Cl. CPC G06Q 30/0185; G06Q 20/38215; G06Q 20/3278; G06Q 20/3276; G06Q 10/083

(57) ABSTRACT

A system, method, and platform for creating NFT for a physical asset and validating the authenticity of a physical asset are described. The system receives a request to validate a physical asset associated with an NFT and retrieves a media file used to create the NFT and first unique identity information present in the media file, using blockchain resources. The system displays a set of information associated with the physical asset and initiates a tag reader of a first user device to read an identifier attached with the physical asset. The tag reader can be a QR code scanner or Near-field Communication (NFC) reader. The system matches the first unique identity with the identifier to check the authenticity of the NFT asset and validates the physical asset based on matching the first unique identity with the identifier.

### FIELD OF THE DISCLOSURE

The present disclosure generally relates to systems and methods for tracking the authenticity of assets. The present disclosure particularly relates to the system and method for creating Non-Fungible Token (NFT) from physical assets and validating the authenticity of digital assets and physical assets associated with an NFT.

### BACKGROUND OF THE DISCLOSURE

E-commerce transactions related to Non-fungible Token (NFT) assets are gaining a lot of traction across the globe. The term fungible means something that can be replaced by something similar. An NFT is a type of token that can't be replaced by another similar token. It is unique and non-interchangeable. A Non-Fungible token (NFTs) is a digital asset that represents real-world objects, like artwork, music, in-game item, video, sports highlights, collectibles, virtual avatars, designer sneakers, etc. The NFT has become a new class of assets that people want to trade. NFTs allows artists and content creators a unique opportunity to monetize their creativity. Artists no longer have to rely on galleries or auction houses to sell their art.

Instead, the artist can sell it directly to the consumer as an NFT, which also lets them keep more of the profits. In addition, the smart contract of the NFT platform allows artists to program in royalties from the future transaction, so they'll receive a percentage of sales whenever their art is sold to a new owner. This is an attractive feature as artists generally do not receive future proceeds after their art is first sold. NFTs are not limited to transacting arts and can enable the transaction of any digital and physical assets having a unique attribute. Brands like Charmin and Taco Bell have auctioned off themed NFT art to raise funds for charity. Nyan Cat, a 2011-era GIF of a cat with a pop-tart body, sold for nearly $600,000 in February 2021. An NBA Top Shot generated more than $500 million in sales as of late March. A single LeBron James highlight NFT fetched more than $200,000. Celebrities are using this opportunity to capture and release unique memories, artwork, and moments as securitized NFTs. There are many platforms that allow the creation of an NFT from an uploaded digital asset, the listing of NFT assets, and buy/sell transactions.

However, these platforms cannot validate and track the authenticity of the physical asset associated with an NFT. Existing platforms do not event support secure handover of the physical assets if a user buys the NFT along with the intent to take control of the associated physical asset.

### OBJECTS OF THE INVENTION

An object of the present invention is to provide a system and method for linking physical assets with an NFT.

An object of the present invention is to provide a platform that helps to create an NFT for a physical asset.

An object of the present invention is to provide a platform for validating the authenticity of a physical asset associated with an NFT.

An object of the present invention is to provide a platform that can allow users to claim physical assets associated with an NFT.

An object of the present invention is to provide a system and method for creating an NFT from a physical asset and tracking the authenticity of the physical asset.

### BRIEF SUMMARY OF THE DISCLOSURE

A system, method, and platform for creating NFT for a physical asset and validating the authenticity of a physical asset are described. According to an embodiment, the system receives a request to validate a physical asset associated with an NFT from a first user through an application interface running on a first user device. Based on the request, the system causes to retrieve a media file used to create the NFT and first unique identity information present in the media file, using blockchain resources. The system displays, at the first user device, a set of information associated with the physical asset and initiates a tag reader of a first user device to read an identifier attached with the physical asset. The tag reader can be a QR code scanner or Near-field Communication (NFC) reader. The system matches the first unique identity with the identifier to check the authenticity of the NFT asset and validates the physical asset based on matching the first unique identity with the identifier.

In an embodiment, the system creates the NFT for a physical asset in such a way that validation of physical assets can be performed when needed. The system may receive, at a user device, an instruction from a user through an application interface to create an NFT for a physical asset. On receiving a request to create the NFT, the system initiates the camera module of the user device to create a media file of the physical asset, reads a unique identity of the physical asset, associates the unique identification with the media file, and creates an NFT using an NFT standard from the media file. The system uses blockchain resources for minting the NFT. The system may help store the NFT in a wallet associated with the creator and allow transferring of the NFT from one owner to another. The system maintains transaction reports in the blockchain ledger.

In an embodiment, the system may share the set of information including but limiting to the location of a physical asset, contact details of the present owner, and schedule time of collection to the new owner. The system may be configured to use any of the NFT standards, including but not limited to ERC-721, ERC-998, ERC-1155, and Flow. The blockchain resources and the wallet that the system and user devices use need to be in the same ecosystem.

The system can enable a user to claim the physical asset and book shipment of the physical asset from the application interface. The proposed system comes in very handy for users who buy the NFT and wish to claim the physical asset associated with the NFT.

In an embodiment, the system enables a user to take a photo or video of a physical asset, generates NFT from the photo or video, and generates a QR code embedding the NFT ID that the NFT creator can fix to the physical asset. A buyer can buy the NFT from a listed marketplace and can validate the physical asset by scanning the QR code fixed with the physical asset. The QR code can only be read by a compliant blockchain application triggered QR code reader.

In an embodiment, the system, while generating the NFT, can also match metadata describing the physical asset with external sources. The system includes a fact check engine that can validate the facts stated to describe the physical asset. The fact check engine can extract a relevant keyword from metadata, form a search string, get relevant results, and compare the facts mentioned as part of metadata with facts stated in the relevant results and confirm the authenticity of the fact. The system can be configured to generate the NFT only after facts are validated.

In an embodiment, the system may take the fact mentioned during the NFT creation request at face value if the fact is stated by a person of authority (e.g., Govt. official, celebrities, known sports person, etc.).

The Features and advantages of the subject matter hereof will become more apparent in light of the following detailed description of selected embodiments, as illustrated in the accompanying FIGUREs. As will be realized, the subject matter disclosed is capable of modifications in various respects, all without departing from the scope of the subject matter. Accordingly, the drawings and the description are to be regarded as illustrative.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 is a block diagram illustrating a network view of an NFT creation and physical asset authenticity tracking system in accordance with an embodiment of the present disclosure.

FIG. 2 illustrates the functional modules of an NFT creation and physical asset authenticity tracking system in accordance with an embodiment of the present disclosure.

FIG. 3A shows a generalized embodiment of an exemplary computing device used by a user or creator to access the system in accordance with an embodiment of the present disclosure.

FIG. 3B a block diagram illustrating the component of a mobile device used by a user or creator to access the system in accordance with an embodiment of the present disclosure.

FIG. 4 is an example block diagram illustrating the submission of an asset and the creation of NFT in accordance with an embodiment of the present disclosure.

FIG. 5 is an example sequence diagram illustrating the interaction between different components of the system in accordance with an embodiment of the present disclosure.

FIG. 6 illustrates an example process of generating a QR code or programming the NFC tag to be fixed with a physical asset in accordance with an embodiment of the present disclosure.

FIG. 7 illustrates an example process of confirming the authenticity of a physical asset in accordance with an embodiment of the present disclosure.

### DETAILED DESCRIPTION

In the following description, for purposes of explanation, numerous specific details are outlined in order to provide a thorough understanding of the present disclosure. It will be apparent, however, to one skilled in the art that the present disclosure is not limited to these specific details.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments.

Further, the terms “a” and “an” herein do not denote a limitation of quantity but rather denote the presence of at least one of the referenced items. As used in the description herein and throughout the claims that follow, the meaning of “a,” “an,” and “the” includes plural reference unless the context dictates otherwise. Also, as used in the description herein, the meaning of “in” includes “in” and “on” unless the context dictates otherwise.

Moreover, various features are described, which may be exhibited by some embodiments and not by others. Similarly, various requirements are described, which may be requirements for some embodiments but not for other embodiments.

Furthermore, in the following detailed description of the present disclosure, numerous specific details are outlined to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Embodiments of the present disclosure include various steps, which will be described below. The steps may be performed by hardware components or may be embodied in machine-executable instructions, which may be used to cause a general-purpose or special purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program the computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other types of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within the single computer) and storage systems containing or having network access to a computer program(s) coded following various methods described herein and the method steps of the disclosure could be accomplished by modules, routines, subroutines, or subparts of a computer program product.

Embodiments described herein may be discussed in the general context of computer-executable instructions residing on some form of computer-readable storage media, such as program modules, executed by one or more computers or other devices. By way of example, and not limitation, computer-readable storage media may include non-transitory computer-readable storage media and communication media; non-transitory computer readable media include all computer-readable media except for a transitory, propagating signal. Generally, program modules include routines, programs, objects, components, data structures, etc., that perform particular tasks or implement abstract data types. The functionality of the program modules may be combined or distributed as desired in various embodiments.

Some portions of the detailed description that follows are presented and discussed in terms of a process or method. Although steps and sequencing thereof are disclosed in figures herein describing the operations of this method, such steps and sequencing are exemplary. Embodiments are well suited to performing various other steps or variations of the steps recited in the flowchart of the figure herein and in a sequence other than that depicted and described herein. Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result.

In some implementations, the flowchart and block diagrams in the Figures illustrate the architecture, functionality, and operation of possible implementations of apparatus (systems), methods, and computer program products according to various implementations of the present disclosure. Each block in the flowchart and/or block diagrams, and combinations of blocks in the flowchart and/or block diagrams, may represent a module, segment, or portion of code, which includes one or more executable computer program instructions for implementing the specified logical function(s)/act(s). These computer program instructions may be provided to a processor of a general-purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of order noted in the figures. For example, two blocks shown in succession may be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer-implemented process such that the instructions which execute on the computer or other programmable apparatus provide steps for implementing the functions/acts (not necessarily in a particular order) specified in the flowchart and/or block diagram block or blocks or combinations thereof.

### Terminology

Brief definitions of terms used throughout this application are given below.

The terms connected, coupled, and related terms are used in an operational sense and are not necessarily limited to a direct connection or coupling. Thus, for example, two devices may be coupled directly or via one or more intermediary media or devices. As another example, devices may be coupled in such a way that information can be passed therebetween while not sharing any physical connection. Based on the disclosure provided herein, one of ordinary skill in the art will appreciate a variety of ways in which connection or coupling exists in accordance with the aforementioned definition.

As used herein, a token assignment refers to assigning an NFT to a digital file (e.g., JPEG, PDF, DOC. Etc.) by associating user/subject rights and restrictions with established identities.

While embodiments of the present disclosure have been illustrated and described, it will be clear that the disclosure is not limited to these embodiments only. Numerous modifications, changes, variations, substitutions, and equivalents, will be apparent to those skilled in the art without departing from the spirit and scope of the disclosure, as described in the claims.

Thus, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular name.

In an embodiment, a system implemented over a distributed computing resources that have one or more computer systems subscribed to work in accordance with a mutually agreed mechanism to cryptographically encrypting data and transactions, storing the data and transaction records in Blockchain across multiple nodes, and validate those data and transactions when requested.

The term “blockchain” as used here refers to any electronic, computer-based, distributed ledger. It should be noted that the disclosure is not limited to use with NFTs and alternative blockchain implementations and protocols fall within the scope of the present disclosure. Blockchain is a distributed ledger technology that allows many users to conduct transactions while maintaining an immutable record of those events. A network of nodes must first agree that a matching transaction is legitimate before moving anything of value via any type of Blockchain. Blockchain ledgers may be administered autonomously to transmit information between remote participants as a peer-to-peer network paired with a distributed time-stamping server. In effect, the blockchain users are the administrator. Blockchain's rapid development has given rise to many different kinds of chains, tokens, and smart contracts. Within a single blockchain, a miner has visibility to all transactions on the single Blockchain. However, the miner does not have visibility, for example, to pending transactions on another blockchain.

The term NFT here refers to non-fungible tokens which is a digital asset that symbolizes physical objects such as art, music, in-game goods, and movies. The NFTs can be created for digital assets as well. For example, NFTs can be created for video, image, data, social media feed, or the likes. NFT can be purchased and sold online in exchange for bitcoin or any other fiat currency. NFT also allows the buyer to retain ownership of the original item.

Each NFT contains a digital signature that prevents NFTs from being traded to one another. An NFT is minted from digital assets that represent both tangible and intangible commodities, such as art, GIFs, films, sports highlights, Collectibles, virtual avatars, video game skins, designer shoes, or music. At any given moment, NFTs can only have one owner because NFTs include unique data. It is simple to verify ownership and transfer tokens between owners. Artists and content providers may use NFTs to monetize their work. For example, an artist can no longer have to sell their work through galleries or auction houses. Instead, the artist may sell it as an NFT straight to the consumer, allowing him to keep a larger portion of the profit. For performing all these transactions, the user requires a proper marketplace platform where a listing of tokens takes place using a smart contract.

A smart contract here refers to the piece of software present in the utility of Blockchain for keeping a record of any transaction in a blockchain. Smart contracts are executed by a computer network uses consensus protocols to agree upon the sequence of actions resulting from the contract's code. With a shared database running a blockchain protocol, smart contracts auto-execute, and all parties validate the outcome instantaneously and without the need for a third-party intermediary. The smart contract helps in the listing of NFTs. The NFT may be associated with an expiration term and, in an event exchange of the NFT is not completed before the expiration term expires, an embodiment may unwind the NFT.

The digital assets may include every intangible item, which may include digital documents, securities, videos, images, etc. It also includes physical assets that are movable as well as immovable property and can be converted to a digital asset by capturing, uploading, or entering on a platform. Each digital asset not only holds a uniquely identifying NFT but also holds associated rights with it, and any transfer of NFT leads to the transfer of these rights also.

The marketplace is a platform that provides buying and selling of NFTs, digital assets, and associated physical assets. The marketplace may be a generic market place or personalized market place dedicated to a player, game, movie, product house, actor, actress, or to any specific theme.

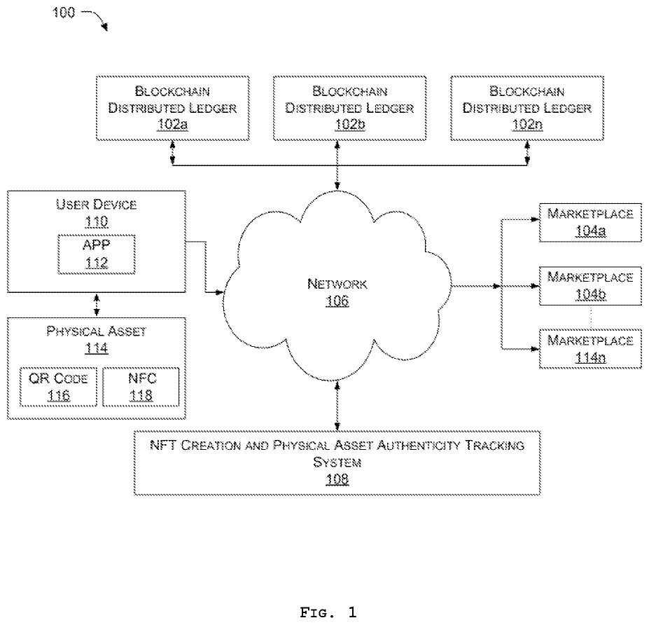

FIG. 1 is a block diagram illustrating a network view of an NFT creation and physical asset authenticity tracking system in accordance with an embodiment of the present disclosure. The NFT creation and physical asset authenticity tracking system 108 allows a user connected through network 106 from a user device 110 running custom application 112 to create an NFT for a physical asset 114. System 108 on, receiving instruction from the user, on user device 112, initiates the camera module of the user device 112 guides guide the user to create a media file, which may be an image or video. The user device 110 may scan the QR code 116 or NFC tag 118 attached with the physical asset 114 and include a unique identifier read from QR code 116 or NFC tag 118 as part of the media file being created. System 108 using the distributed blockchain resources may create NFT from the media file. System 108 allows users to place the NFT in the marketplace (e.g., marketplace 104a, marketplace 104b, marketplace 104n, etc.). The system anchors the NFT in Blockchain distributed ledger (e.g., blockchain distributed ledger 102a, Blockchain distributed ledger 102b, blockchain distributed ledger 102n, etc.).

System 108 works as a platform to connect creators, buyers, sellers, advertisers using the blockchain ecosystem. The user device may include every electronic device which is connected to the Internet, such as laptop, mobile device, tablet PC, etc. Multiple users are allowed to perform functions on a platform, and users can join the platform from multiple devices also. User Device may include one or more user interfaces, such as browsers and textual or graphical user interfaces, through which users may access system 108.

The system 108 use blockchain infrastructure to store the transactions in distributed ledgers and execute a smart contract to facilitate buy and sell transaction of the NFT. Smart contracts are used to generate transactions which are subsequently distributed to every peer node in the network, where they are immutably recorded on their copy of the ledger. System 108 may use distributed storage, which is responsible for keeping a record of already assigned NFTs, and transaction of NFTs.

The user device may have a digital wallet associated with the system for holding crypto assets. The custom application 112 can be integrated with the digital wallet or can interact with the digital wallet using suitable APIs. A user, who may be a content creator, can create NFT for the physical asset or create a digital document and associate a physical asset with that.

System 108 on receiving a media can generate an NFT using an NFT standard and anchor the NFT into Blockchain distributed ledger (e.g., Blockchain distributed ledger 102a, Blockchain distributed ledger 102b, and Blockchain distributed ledger 102n). In an embodiment, the system supports minting of NFTs and places the request for NFT at suitable based on operational price to minimize the cost.

System 108 allows a user (e.g., a buyer) to verify the authenticity of a physical asset associated with an NFT. A user can make a request through an application interface to system 108 to get details about the physical asset and verify its authenticity. To ensure the authenticity of the physical asset associated with the NFT, system 108 may generate a QR code that can be fixed on the physical asset or program the NFC tag with NFT details that can be tagged with the physical asset. A buyer can send a request for validation and handover of a physical asset associated with an NFT.

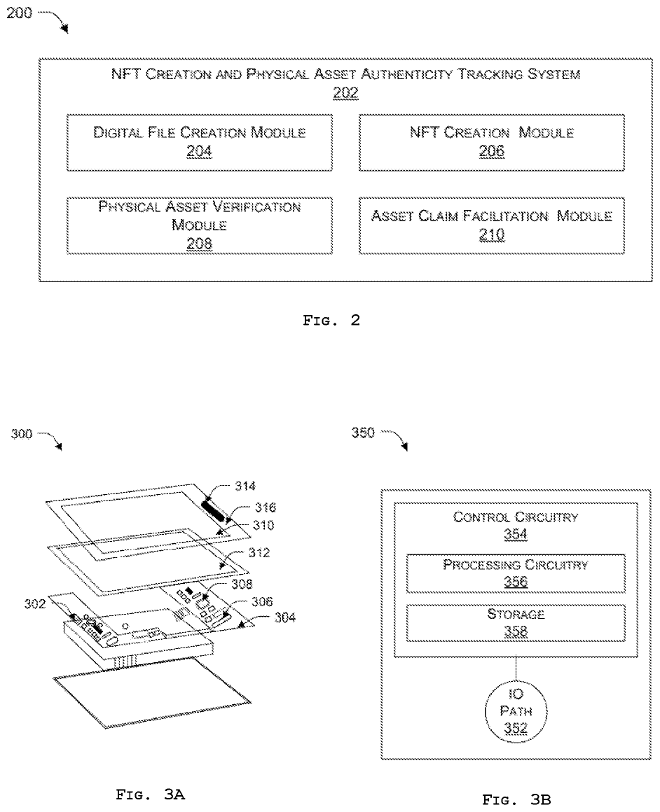

FIG. 2 illustrates the functional modules of an NFT creation and physical asset authenticity tracking system in accordance with an embodiment of the present disclosure. The NFT creation and physical asset authenticity tracking system 202 (same as system 108) enables the creation of an NFT for a physical asset and helps a user validate the authenticity of a physical asset associated with an NFT. The system includes a digital file creation module 204 configured to initiate a camera of the user device and guide a user to create a digital file (also referred interchangeably as media file) for a physical asset. The digital file can be a digital twin of the physical asset or an image of the physical asset, or a video of the physical asset. The digital file creation module 204 can capture a QR code or read the NFC tag attached with the physical asset for retrieving the unique identity of the physical asset. In an embodiment, the QR code or NFT tag attached with the physical asset needs to be tamper-resistant and nonremovable.

System 202 includes an NFT creation module 206 configured to create an NFT from the digital file using an NFT standard. The NFC creation module 206 uses digital files and associated metadata to create the NFT. The associated metadata includes a unique identity of the physical asset, description of the file, importance of the asset, uniqueness of the asset explained from the creator's point of view, location information, event information, data, etc. The NFC creation module 206 may restrict the creation of more than one NFT for an asset if it represents a physical asset, as there can be only one person who may have the physical asset. The NFT creation module 206 records ownership of the NFT in a blockchain corresponding to the NFT standard and associates a smart contract with the NFT. The smart contract contains machine-readable instructions related to the terms of commercial transactions.

The NFT creation module 206 may have a fact check engine configured to validate the facts stated to describe the physical asset. The fact check engine can extract a relevant keyword from metadata, form a search string, get relevant results, and compare the facts mentioned as part of metadata with facts stated in the relevant results and confirm the authenticity of the fact. The system can be configured to generate the NFT only after facts are validated.

In an embodiment, the system may take the fact mentioned during the NFT creation request at face value if the fact is stated by a person of authority (e.g., Govt. official, celebrities, known sports person, etc.)

System 202 includes a physical asset verification module 208 configured to allow a user to verify or validate the authenticity of a physical asset associated with an NFT. The physical asset verification module 208 may receive a physical asset validation request for an NFT from a user. The user may place the asset validation request from an application interface supported by system 202. The physical asset verification module 208 causes to retrieve a media file used to create the NFT and first unique identity information present in the media file, using blockchain resources. Module 208 may display, at the user device, a set of information associated with the physical asset. The set of information includes but is not limited to the location of a physical asset, contact details of the present owner, and schedule time of collection to the new owner. The user (buyer or new owner) can reach the physical asset based on the shared information. Module 208 can initiate a tag reader of the user device to read an identifier attached with the physical asset. The tag reader can be a QR code scanner or Near-field Communication (NFC) reader. Module 208 matches the unique identity (also referred to as the first unique identity) of the physical asset associated with the NFT, with identity information read by scanning the physical asset to check the authenticity of the NFT asset. Module 208 validates the physical asset based on matching the first unique identity with the identifier.

System 202 includes an asset claim facilitation module 210 that allows a user to claim the physical asset and book shipment of the physical asset from the application interface. Module 210 provides an option for self-pick-up or online delivery of the physical asset. Module 210 may guide the user for self-pickup to reach the location of the physical asset. The asset claim facilitation module 210 also presents a checklist for taking handover of the physical asset. Depending on the category of a physical asset, module 210 may present the appropriate checklist. In an embodiment, module 210 may present the unique attributes of the physical asset described at the time of creating the NFT to the user. Module 210 may guide the user to make an image of the physical asset from different angles and compare the same with the digital file created at the time of creating the NFT. If the image taken by the buyer matches the images used for creating NFT, the system can verify the authenticity of the physical asset.

In an embodiment, system 202 enables a user to take a photo or video of a physical asset, generates NFT from the photo or video, and generates a QR code embedding the NFT ID that the user (the NFT creator) can fix to the physical asset. A buyer can buy the NFT from a listed marketplace and can validate the physical asset by scanning the QR code fixed with the physical asset. The QR code can only be read by a compliant blockchain application triggered QR code reader.

System 202 can be configured to use any of the NFT standards, including but not limited to ERC-721, ERC-998, ERC-1155, and Flow.

FIG. 3A shows a generalized embodiment of an exemplary computing device used by a user or creator to access the system in accordance with an embodiment of the present disclosure. As depicted, the computing device 300 may be a smartphone or a tablet. The computing device 300 may receive content and data via an input/output (hereinafter “I/O”) path 302. The I/O path 302 may provide metadata, voice profiles, and/or voice clips to control circuitry 304, which includes processing circuitry 306 and storage 308. The control circuitry 304 may send and receive commands, requests, and other suitable data using the I/O path 302. The I/O path 302 may connect the control circuitry 304 (and specifically the processing circuitry 306) to one or more communications paths (described below). I/O functions may be provided by one or more of these communications paths but are shown as a single path in FIG. 3A to avoid overcomplicating the drawing.

The control circuitry 304 may be based on any suitable processing circuitry, such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quadcore, Hexa-core, or any suitable number of cores) or supercomputer. In some embodiments, the processing circuitry is distributed across multiple separate processors or processing units of different types, for example, multiple of the same type of processing units (e.g., two Intel Core i7 processors) or multiple different processors (e.g., an Intel Core i5 processor and an Intel Core i7 processor).

In some embodiments, the control circuitry 304 executes instructions for facilitating real estate transactions stored in memory (i.e., storage 308). Specifically, the control circuitry 304 may be instructed to perform searching, retrieve data and/or voice profiles or voice clips, and/or perform the other functions discussed above and below.

In client/server-based embodiments, the control circuitry 304 includes communications circuitry suitable for communicating with a real estate transaction facilitation platform or other networks or servers. The instructions for carrying out the above-mentioned functionality may be stored on a server or a cloud database. Communications circuitry may include a cable modem, integrated services digital network (ISDN) modem, a digital subscriber line (DSL) modem, a telephone modem, an Ethernet card, or a wireless modem for communications with other equipment, or any other suitable communications circuitry. Such communications may involve the Internet or any other suitable communications networks or paths. In addition, communications circuitry may include circuitry that enables peer-to-peer communication of client devices or communication of media devices in locations remote from each other.

The memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, hard drives, optical drives, solid-state devices, quantum storage devices, or any other suitable fixed or removable storage devices, and/or any combination of the same. Non-volatile memory may also be used (e.g., to launch a boot-up routine and other instructions). Cloud-based storage may be used to supplement the storage 308 or instead of the storage 308.

The control circuitry 304 may include audio processing circuitry and/or audio generation circuitry, other digital encoding or decoding circuitry, or any other suitable audio circuits or combinations of such circuits. Encoding circuitry (e.g., for converting received audio input or digital signals to audio signals for analysis or storage) may also be provided. The audio circuitry may be used by the computing device 300 to receive, process, and generate audio input or output. The circuitry described herein, including, for example, audio generating, encoding, decoding, encrypting, decrypting, and analog/digital circuitry, may be implemented using software running on one or more general-purpose or specialized processors. Multiple circuits may be provided to handle simultaneous processing functions. If storage 308 is provided as a separate device from the media device 300, the circuitry may be associated with storage 308.

A user may send instructions to the control circuitry 304 using a user input interface 310 of the computing device 300. The user input interface 310 may be any suitable user interface, such as a remote control, mouse, trackball, keypad, keyboard, touch screen, touchpad, stylus input, joystick, or other user input interfaces. Display 312 may be a touchscreen or touch-sensitive display. In such circumstances, user input interface 310 may be integrated with or combined with the display 312. A camera, microphone 316, or other visual or voice recognition interface may also be used to receive user input (e.g., voice prompts). Speakers 314 may be provided as integrated with other elements of the computing device 300.

The interactive application and/or any instructions for performing any of the embodiments discussed herein may be encoded on computer-readable media. Computer readable media includes any media capable of storing data. In some embodiments, the real estate transaction facilitation application is a client/server-based application. Data for use by a thick or thin client implemented on the computing device 300 is retrieved on-demand by issuing requests to a server remote to the computing device 300, as described above. For example, the computing device 300 may receive inputs from the user via the input interface 310 or the microphone 316 and transmit those inputs to the remote server (e.g., cloud database 208) for processing and generating the corresponding outputs. The generated output is then transmitted to the computing device 300 to be output to the user. Those skilled in the art will appreciate that respective client devices used by different stack holder 202a-i may be implemented as media device 300 of FIG. 3A.

FIG. 3B a block diagram illustrating the component of a mobile device used by a user or creator to access the system in accordance with an embodiment of the present disclosure. The mobile device 350 may receive data related to NFT listing and transactions via an input/output path 352. The I/O path 352 may provide data related to NFT based transactions and other required services to control circuitry 354. Control 354 includes a processing circuitry 356 configured to process the data and execute instructions to perform functions of the system 400 described above. The control circuitry 354 includes a storage 358 that stored programmable instructions and other data relating to NFT transactions. The control circuitry 354 may send and receive commands, requests, and other suitable data using the I/O path 352. The I/O path 352 may connect the control circuitry 354 to one or more communications paths.

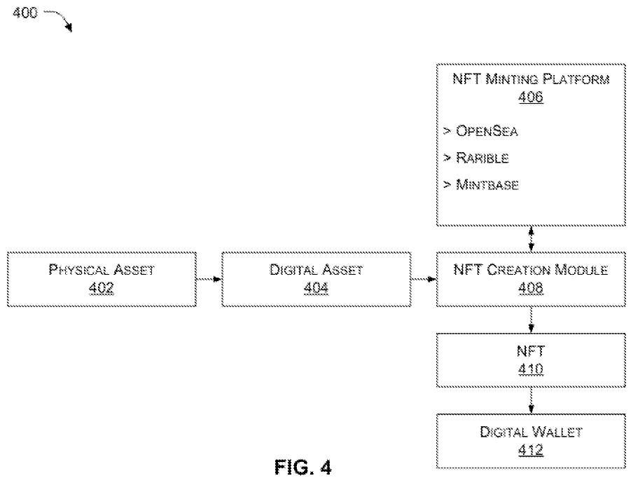

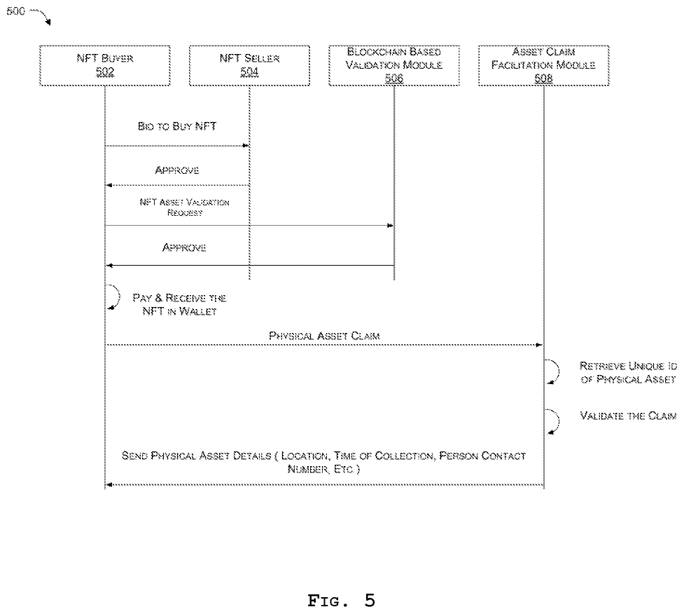

FIG. 4 is an example block diagram illustrating the submission of an asset and the creation of NFT in accordance with an embodiment of the present disclosure. As shown in FIG. 4, a digital asset 404 from a physical asset 402 is created. The digital asset 404 can be a digital twin or digital replica of the physical asset 402, or image of the physical asset 402, or a video of the physical asset 402. The digital asset 404 also includes metadata description of the physical asset, owner details, unique features of the physical asset or its digital twin. The digital asset 404 may also be a digital artistic creation (e.g., GIF, image, etc.) representing physical asset 402. The user may create NFT and attach the physical asset as a tie-along right for the buyer. The NFT creation module 408 (same as NFT creation module 206) may receive the digital asset 404 and, using a suitable NFT mining platform 406, create an NFT 410. The NFT 410 can be stored as a crypto asset in digital wallet 412 of the user (e.g., the creator).

In an embodiment, the physical asset 402 may have a QR code or NFC tag attached with it to provide its unique identity. While creating the digital asset 404, system 202 may read the unique identity (also referred to as identifier) of the physical asset from the QR code or from the NFC tag. In an alternative embodiment, the system can take a raw image or video of the physical asset, create NFT from the raw image or video, and create a QR code or NFC tag to include the NFT ID. The unique identity can be assigned to the physical asset.

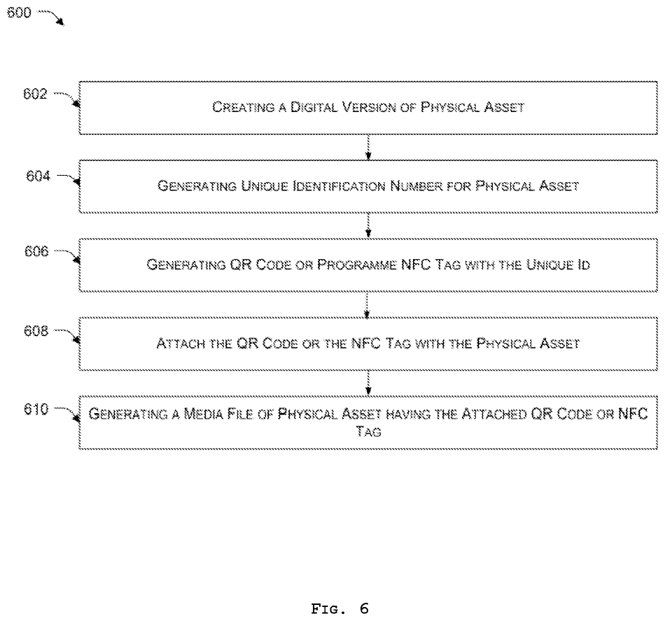

FIG. 5 is an example sequence diagram illustrating the interaction between different components of the system in accordance with an embodiment of the present disclosure. An NFT buyer 502 can bid to buy an NFT asset from NFT seller 504. The NIFT buyer 502 and NFT seller 504 may have peer-to-peer connectivity, or they may be connected through an exchange or marketplace. If the NFT buyer 502 is buying through an exchange, the exchange may facilitate the bidding the send a buy request to NFT seller 504. The NFT seller 504 may approve the NFT sell. System 202 allows the NFT buyer 502 to initiate an NFT asset validation request. The NFT asset validation request is sent to Blockchain based validation module 506. The blockchain-based validation module 506 can use a blockchain network of peer devices to authenticate ownership of NFT and its present state. If the ownership and state are consistent, module 506 may approve the transaction, and the NFT can be transferred from the NFT seller 504 to NFT buyer 502. The transaction can be recorded in Blockchain. The NFT buyer 502 can pay through cryptocurrency or fiat money. On confirmation of payment, the NFT can be transferred from the wallet of the NFT seller 504 to the wallet of the NFT buyer 502.

The system facilitates an NFT buyer 502 to claim a physical asset associated with the NFT. The NFT buyer 502 may submit a physical asset claim to an asset claim facilitation module 508. Module 508 performs further steps only when the request is coming from a new NFT owner. The asset claim facilitation module 508 retrieves the unique ID of the physical asset and also the present ownership of the NFT asset. In an embodiment, the asset claim facilitation module 508 validates the claims and sends physical asset details, such as location, time of collection, personal contact number, etc. The asset claim facilitation module 508 also guides the NFT buyer to verify the physical asset. The NFT buyer, while receiving the physical asset, may scan the QR code or read the NFC tag attached with the physical asset and compare the same with the code or tag information read at the time of creating the digital asset.

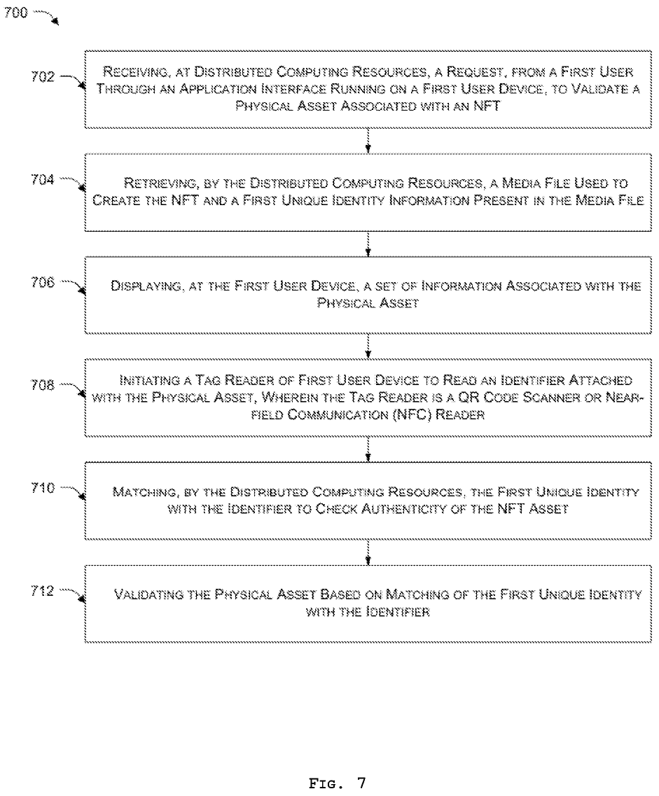

FIG. 6 illustrates an example process 600 of generating a QR code or programming the NFC tag to be fixed with a physical asset in accordance with an embodiment of the present disclosure. Process 600 includes steps of creating a digital version of a physical asset, as shown at block 602, generating a unique identification number for the physical asset, as shown at block 604, generating QR code or programming NFC tag with the unique ID, as shown at block 606, and attaching the QR code or the NFC tag with the physical asset, as shown at block 608. Process 600 includes the step of generating a media file of a physical asset having the attached QR code or NFC tag as shown in block 610. System 202 may use the media file to generate the NFT. Process 600 ensure that the media file used to generate the NFT has an identity of the physical asset embedded in it.

FIG. 7 illustrates an example process 700 of confirming the authenticity of a physical asset in accordance with an embodiment of the present disclosure. Process 700 includes steps of receiving a request to validate a physical asset associated with an NFT, as shown at block 702, retrieving a media file used to create the NFT and first unique identity information present in the media file, as shown at block 704, displaying a set of information associated with the physical asset, as shown at block 706, initiating a tag reader of the first user device to read an identifier attached with the physical asset as shown at block 708,

matching the first unique identity with the identifier to check the authenticity of the NFT asset, as shown at block 710, and validating the physical asset based on matching of the first unique identity with the identifier, as shown at block 712.

The request to validate a physical asset is received at distributed computed resources from a first user (e.g., buyer) through an application interface running of a first user device (buyer's device). The distributed computing resources, which includes blockchain nodes, retrieve the media file used to create the NFT using blockchain. Process 700 causes the display of the set of information associated with the physical asset on the first user device (e.g., buyer's device). The information may help the first user to reach the physical asset. The application interface on the first user device guides the user to an image of the physical asset, or scan the QR code or read the NFC tag attached with the physical asset. Process 700 may use corresponding information (image, QR code, NFC tag) captured while creating the NFC to verify the identity.

### Advantages of the Invention

The proposed invention provides a system and method for linking physical assets with an NFT.

The proposed invention provides a platform that helps to create an NFT for a physical asset.

The proposed invention provides a platform for validating the authenticity of a physical asset associated with an NFT.

The proposed invention provides a platform that can allow users to claim physical assets associated with an NFT.

The proposed invention provides a system and method for creating an NFT from a physical asset and tracking the authenticity of the physical asset.

We claim:

1. A method for validating the authenticity of an NFT associated asset and enabling handover of the NFT associated asset, the method comprising:
receiving, at distributed computing resources, a request, from a first user through an application interface running on a first user device, to validate a physical asset associated with an NFT;
retrieving, by the distributed computing resources, a media file used to create the NFT and first unique identity information present in the media file;
displaying, at the first user device, a set of information associated with the physical asset;
initiating a tag reader of a first user device to read an identifier attached with the physical asset, wherein the tag reader is a QR code scanner or Near-field Communication (NFC) reader;
matching, by the distributed computing resources, the first unique identity with the identifier to check the authenticity of the NFT asset; and
validating the physical asset based on matching the first unique identity with the identifier.

2. The method of claim 1, wherein the NFT is created for the physical asset by
receiving, at a second user device, an instruction from a second user through an application interface to create an NFT for a physical asset;
initiating camera module of the second user device to create a media file of the physical asset;
reading, by the second user device, a unique identity of the physical asset;
associating the unique identification with the media file; and
creating, using distributed computing resources, and NFT using an NFT standard from the media file.

3. The method of claim 1, wherein the set of information comprises a location of a physical asset, contact details of the present owner, and schedule time of collection.

4. The method of claim 2, wherein the NFT standard comprises ERC-721, ERC-998, ERC-1155, and Flow.

5. The method of claim 1, wherein the NFC is minted by blockchain infrastructure using a supported application program interface.

6. The method of claim 1, further comprising allowing the user to claim the physical asset and book shipment of the physical asset from the application interface.

7. A system for validating the authenticity of an NFT associated asset and enabling handover of the NFT associated asset, the system comprising:
a physical asset validation module configured to
receive a request from a first user through an application interface running on a first user device to validate a physical asset associated with an NFT;
retrieve, using blockchain resources, a media file used to create the NFT and first unique identity information present in the media file;
display, at the first user device, a set of information associated with the physical asset;
initiate a tag reader of the first user device to read an identifier attached with the physical asset, wherein the tag reader is a QR code scanner or Near-field Communication (NFC) reader;
match the first unique identity with the identifier to check the authenticity of the NFT asset; and
validate the physical asset based on matching the first unique identity with the identifier.

8. The system of claim 7, further comprising an NFT creation module configured to create the NFT for the physical asset by
receiving, at a second user device, an instruction from a second user through an application interface to create an NFT for a physical asset;
initiating camera module of the second user device to create a media file of the physical asset;
reading, by the second user device, a unique identity of the physical asset;
associating the unique identification with the media file; and
creating, using distributed computing resources, an NFT using an NFT standard from the media file.

9. The system of claim 7, wherein the set of information comprises a location of a physical asset, contact details of the present owner, and schedule time of collection.

10. The system of claim 8, wherein the NFT standard comprises ERC-721, ERC-998, ERC-1155, and Flow.

11. The system of claim 7, wherein the NFC is minted by blockchain infrastructure using a supported application program interface.

12. The system of claim 7, further comprising allowing the user to claim the physical asset and book shipment of the physical asset from the application interface.
